(19) United States
(12) Patent Application Publication
(10) Pub. No.: US 2023/0397744 A1
(43) Pub. Date: Dec. 14, 2023

(54) FIBER BASKET WITH WATER RETAINING LINER

(71) Applicant: Shantha Athalage, Iselin, NJ (US)

(72) Inventor: Shantha Athalage, Iselin, NJ (US)

(21) Appl. No.: 17/837,222

(22) Filed: Jun. 10, 2022

(51) Int. Cl. A47G 7/04; D06N 3/00; A01G 9/02

(52) U.S. Cl. CPC A47G 7/045; D06N 3/0015; A01G 9/021; D06N 2203/022; D06N 2201/045; D06N 2209/128

(57) ABSTRACT

A system and associated method include coconut fiber liners used in hanging wire flower baskets. The coco fiber basket liner may create a water seal in the liner by over-coating a portion of the inner liner with a unique blend of all-natural rubber latex, then molding the liners into shape. The added latex coating may seal in and hold water in the bottom portion of the liner. This feature may keep the soil moist while still allowing air to flow thru the plants. The moisture and airflow may help promote healthier plants and roots and require less watering. Excess water beyond the intended amount may drain out thru the permeable side walls of the coco liner.

### BACKGROUND

This disclosure relates generally to potted plant containers, such as hanging baskets.

Conventional plant container liners generally consist of two types. Typical plant liners are made of molded coco, some using some synthetic binders to hold the coco fibers in shape. A common problem with these liners is that the water quickly drains out of liner through the bottom and the sides. This drainage causes premature drying out the plant and lack of needed water to plant roots.

Another type of coco liner includes a plastic sheet inserted between two layers of coco material, which creates a built-in water tray to maintain the desired water in the liner. While this approach generally does keep water in the liner as intended, the liner is not fully biodegradable because the insert is made of poly ethylene plastic.

Thus, there is a need for an improved, ecologically sustainable, 100% all natural, 100% biodegradable coco basket liner that effectively contains water to keep roots moist, and which offer the consumers a less expensive alternative than conventional solutions.

### SUMMARY

According to an embodiment, an apparatus includes a fiber layer molded into a basket shape. The coco fiber layer may be water permeable. A sealing layer may cover at least a lower portion of the fiber later. The sealing layer may comprise latex, wherein the sealing layer is water impermeable.

In another or the same example, the apparatus includes a sealing layer that is positioned on an inner side of the fiber layer. The sealing layer of an embodiment may be positioned on an outer side of the fiber layer.

According to the same or another particular embodiment, another sealing layer may be positioned on an opposite side of the fiber layer as the sealing layer, such that the sealing layer and the other sealing layer sandwich the fiber layer.

In one example, the latex may include natural rubber. In another, the latex comprises latex extracted from a rubber tree.

Where desired, the sealing layer may be molded into shape. The lower portion may include a bottom third of the fiber layer. The lower portion may include ten to thirty percent of a bottom portion of the fiber layer. According to an embodiment, a sealing layer is 100% biodegradable. The sealing layer may include pigments to match a color of the fiber layer. The fiber layer may include jute fiber. In another or the same embodiment, the fiber layer comprises coco fiber.

According to another particular embodiment, a method of method of manufacturing a plant container system includes forming a fiber layer molded into a basket shape, wherein the coco fiber layer is water permeable, and forming a sealing layer covering at least a lower portion of the fiber later, the sealing layer comprising latex, wherein the sealing layer is water impermeable.

In another or the same example, the apparatus includes a sealing layer that is positioned on an inner side of the fiber layer. The sealing layer of an embodiment may be positioned on an outer side of the fiber layer.

According to the same or another particular embodiment, another sealing layer may be positioned on an opposite side of the fiber layer as the sealing layer, such that the sealing layer and the other sealing layer sandwich the fiber layer.

In one example, the latex may include natural rubber. In another, the latex comprises latex extracted from a rubber tree.

Where desired, the sealing layer may be molded into shape. The lower portion may include a bottom third of the fiber layer. The lower portion may include ten to thirty percent of a bottom portion of the fiber layer. According to an embodiment, a sealing layer is 100% biodegradable. The sealing layer may include pigments to match a color of the fiber layer. The fiber layer may include jute fiber. In another or the same embodiment, the fiber layer comprises coco fiber.

The above description is provided as an overview of only some implementations disclosed herein. Those and other implementations are described in more detail here. In addition, some implementations include one or more processors of one or more computing devices, where the one or more processors are operable to execute instructions stored in associated memory, and where the instructions are configured to cause performance of any of the methods described herein. Some implementations also include one or more non-transitory computer readable storage media storing computer instructions executable by one or more processors to perform any of the methods described herein.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE SEVERAL VIEWS OF THE DRAWINGS

FIG. 1 is a cross-sectional view of a basket that includes a molded fiber layer in addition to a sealing layer covering that is positioned along a bottom, interior surface of the basket;

FIG. 2 is a cross-sectional view of a basket that includes a molded fiber layer in addition to a sealing layer covering that is positioned along a bottom, exterior surface of the basket;

FIG. 3 is a cross-sectional view of a basket that includes a molded fiber layer in addition to a first sealing layer covering that is positioned along a bottom, interior surface of the basket, as well as a second sealing layer covering that is positioned along a bottom, exterior surface of the basket;

FIG. 4 is a table that shows illustrative water retention liner general specifications; and

FIG. 5 is a flowchart of an embodiment of a method of manufacturing a basket that includes a molded fiber layer in addition to one or more sealing layers.

### DETAILED DESCRIPTION

An embodiment of the system may include coconut fiber liners used in hanging wire flower baskets. The coco fiber basket liner may create a water seal in the liner by over-coating a portion of the inner liner with a unique blend of all-natural rubber latex, then molding the liners into shape. The added latex coating may seal in and hold water in the bottom portion of the liner. This feature may keep the soil moist while still allowing air to flow thru the plants. The moisture and airflow may help promote healthier plants and roots and require less watering. Excess water beyond the intended amount may drain out thru the permeable side walls of the coco liner.

An embodiment may include woven or pressed coco fiber material. The material may be molded into shape of a basket liner. The liner may be single-side coated (e.g., the inner side) with an all-natural latex coating to contain and hold a desired amount of water in the liner to keep the plant roots moist for healthy growth.

According to another or the same embodiment, a woven or pressed coco fiber material may be molded into shape of a basket liner. The liner may be double-side coated with an all-natural latex coating to contain and hold a desired amount of water in the liner to keep the plant roots moist for healthy growth.

In another or the same example, a coco basket liner may include an all-natural rubber sheet for water retention purposes. An embodiment of the liner may be 100% biodegradable, as opposed to other water retention liners that are not.

According to another or the same embodiment, the coco basket liner may include a latex coated section that includes a bottom portion. The coverage of the bottom portion may range from approximately 10-30% of the liner when the bottom portion is molded into shape.

In another or the same example, the coco basket liner may include a latex coating that is natural in color or dyed with natural pigments to closely match the natural color of coco fiber raw material.

According to another or the same embodiment, the coco basket liner may include a latex coated section without limit to the thickness of the coco fiber walls and bottom. Where desired, the coco material is substituted by natural jute fiber or a blend of coco and jute fibers. In another or the same embodiment, the coco basket liner may include a latex made of natural latex extracted from rubber trees.

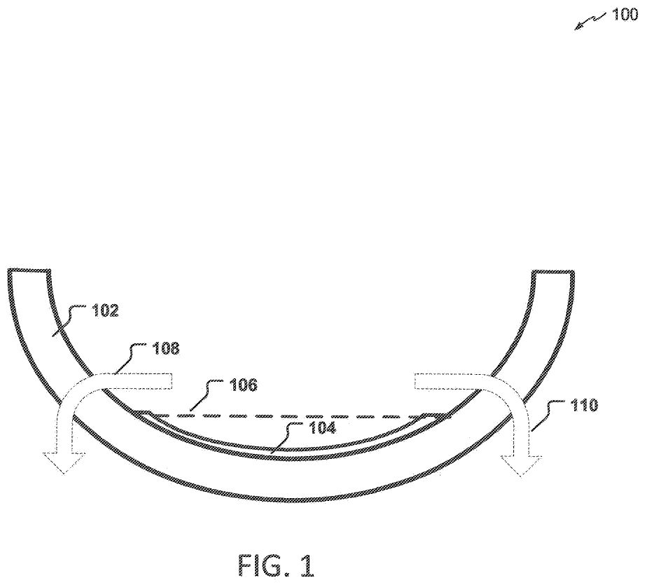

FIG. 1 is a cross-sectional view of a basket 100 that includes a molded fiber layer 102 in addition to a sealing layer 104 covering that is positioned along a bottom, interior surface of the basket 100. The sealing layer 104 may comprise latex in one embodiment. Dashed line 106 may represent where water is contained by the sealing layer 104. As such, excess water may drain through non-sealed portions of the molded fiber layer 102. Dashed arrows 108,110 illustrate water draining from non-sealed portions of the molded fiber layer 102 that are above the sealed water line 106 (e.g., the desired retention level).

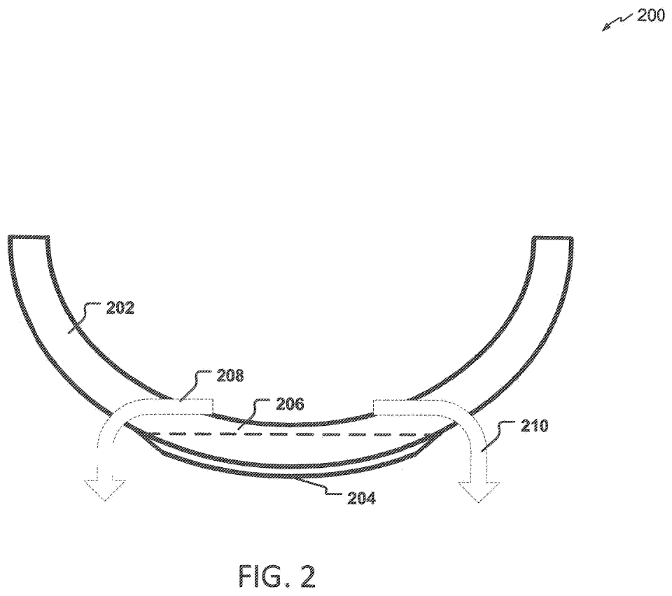

FIG. 2 is a cross-sectional view of a basket 200 that includes a molded fiber layer 202 in addition to a sealing layer 204 covering that is positioned along a bottom, exterior surface of the basket 200. The sealing layer 204 may comprise latex in one embodiment. Dashed line 206 may represent where water is contained by the sealing layer 204. As such, excess water may drain through non-sealed portions of the molded fiber layer 202. Dashed arrows 208, 210 illustrate water draining from non-sealed portions of the molded fiber layer 202 that are above the sealed water line 206 (e.g., the desired retention level).

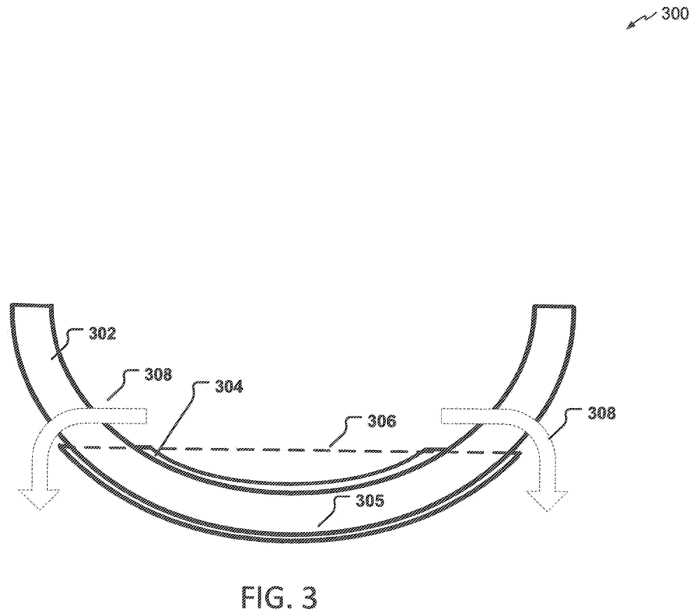

FIG. 3 is a cross-sectional view of a basket 300 that includes a molded fiber layer 302 in addition to a first sealing layer 304 covering that is positioned along a bottom, interior surface of the basket 300, as well as a second sealing layer covering 305 that is positioned along a bottom, exterior surface of the basket 300. The sealing layers 304, 305 may comprise latex in one embodiment. Dashed line 306 may represent where water is contained by the sealing layers 304, 305. As such, excess water may drain through non-sealed portions of the molded fiber layer 302. Dashed arrows 308, 310 illustrate water draining from non-sealed portions of the molded fiber layer 302 that are above the sealed water line 306 (e.g., the desired retention level).

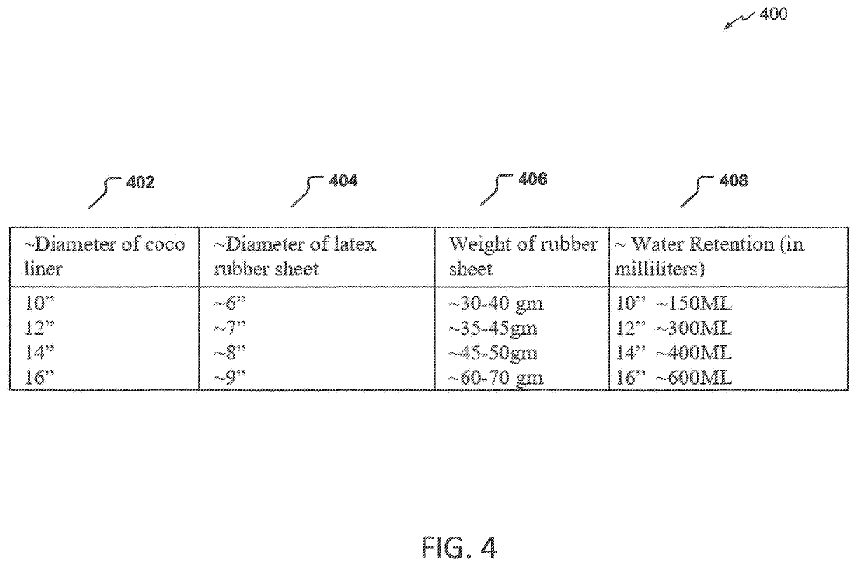

FIG. 4 is a table 400 that shows illustrative water retention liner general specifications. The table 400 includes a first column 402 listing illustrative diameters of a coco liners. Column 404 of the table 400 includes illustrative diameters of latex rubber sheets corresponding to the different diameters of a coco liners listed in column 402. Column 406 of the table 400 includes illustrative weights of rubber sheets corresponding to the different diameters of a coco liners listed in column 402. Column 408 of the table 400 includes illustrative water retention sizes and volumes corresponding to the different diameters of a coco liners listed in column 402.

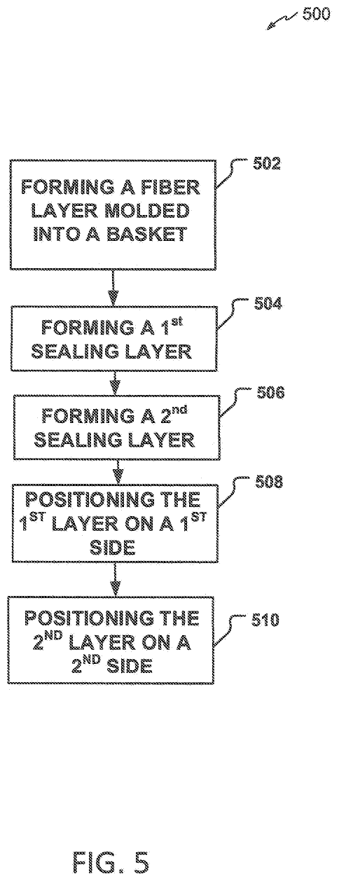

FIG. 5 is a flowchart of an embodiment of a method 500 of manufacturing a basket that includes a molded fiber layer in addition to one or more sealing layers. At 502, the method 500 may include forming a fiber layer into a basket. For instance, coco fiber may be molded into a shape of a basket.

A first sealing layer may be formed at 504. The first sealing layer may comprise a coating of latex in one embodiment. As illustrated at 506, 508, and 510, the first layer may be formed on the interior of the fiber layer. In another embodiment, the first layer may be positioned on the exterior of the fiber layer. As such, the second layer may be formed or otherwise positioned on an opposite side of the fiber layer as the first layer.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems and methods according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. An apparatus comprising:
a fiber layer molded into a basket shape, wherein the coco fiber layer is water permeable; and
a sealing layer covering at least a lower portion of the fiber later, the sealing layer comprising latex, wherein the sealing layer is water impermeable.

2. The apparatus of claim 1, wherein the sealing layer is positioned on an inner side of the fiber layer.

3. The apparatus of claim 1, wherein the sealing layer is positioned on an outer side of the fiber layer.

4. The apparatus of claim 1, further comprising another sealing layer positioned on an opposite side of the fiber layer as the sealing layer, such that the sealing layer and the other sealing layer sandwich the fiber layer.

5. The apparatus of claim 1, wherein the latex comprises all natural rubber.

6. The apparatus of claim 1, wherein the latex comprises latex extracted from a rubber tree.

7. The apparatus of claim 1, wherein the sealing layer is molded into shape.

8. The apparatus of claim 1, wherein the lower portion comprises a bottom third of the fiber layer.

9. The apparatus of claim 1, wherein the lower portion comprises ten to thirty percent of a bottom portion of the fiber layer.

10. The apparatus of claim 1, wherein the sealing layer is 100% biodegradable.

11. The apparatus of claim 1, wherein the sealing layer further comprises pigments to match a color of the fiber layer.

12. The apparatus of claim 1, wherein the fiber layer comprises jute fiber.

13. The apparatus of claim 1, wherein the fiber layer comprises coco fiber.

14. A method of manufacturing a plant container system, the method comprising:
forming a fiber layer molded into a basket shape, wherein the coco fiber layer is water permeable; and
forming a sealing layer covering at least a lower portion of the fiber later, the sealing layer comprising latex, wherein the sealing layer is water impermeable.

15. The method of claim 14, wherein the sealing layer is positioned on an inner side of the fiber layer.

16. The method of claim 14, wherein the sealing layer is positioned on an outer side of the fiber layer.

17. The method of claim 14, further comprising positioning another sealing layer on an opposite side of the fiber layer as the sealing layer, such that the sealing layer and the other sealing layer sandwich the fiber layer.

18. The method of claim 14, wherein the latex comprises all natural rubber.

19. The method of claim 14, wherein the latex comprises latex extracted from a rubber tree.

20. The method of claim 14, wherein the lower portion comprises a bottom third of the fiber layer.
